(19) United States
(12) Patent Application Publication
(10) Pub. No.: US 2024/0143642 A1
(43) Pub. Date: May 2, 2024

(54) Document Matching Using Machine Learning

(71) Applicant: Peruse Technology LLC, Inverness, IL (US)

(72) Inventor: Emilia APOSTOLOVA, Inverness, IL (US)

(73) Assignee: Peruse Technology LLC, Inverness, IL (US)

(21) Appl. No.: 18/384,289

(22) Filed: Oct. 26, 2023

Related U.S. Application Data
(60) Provisional application No. 63/420,994, filed on Oct. 31, 2022.

(51) Int. Cl. G06F 16/35; G06F 3/04842

(52) U.S. Cl. CPC G06F 16/35; G06F 3/04842

(57) ABSTRACT

Disclosed herein are system, method, and computer program product embodiments for identifying document-to-document and/or document-to-entity relationships using machine learning. This may be referred to as document matching. A document matching system may receive a first and a second document and determine whether the documents are associated. For example, a first document may correspond to a contract for a delivery while the second document may correspond to a confirmation of delivery completion. Using machine learning and an analysis of character strings within the documents, the document matching system may identify the documents as matching. The document matching system may also match a document to a data structure representing an entity, such as a delivery, job, and/or shipment contract. The document matching system may also generate a graphical user interface with color highlighting the data fields and values used to determine that the documents are matching.

### CROSS-REFERENCE TO RELATED APPLICATIONS

This application claims priority to U.S. Provisional Patent Application No. 63/420,994 filed on Oct. 31, 2022, which is incorporated by reference herein in its entirety.

### BACKGROUND

### Technical Field

One or more implementations relate to the field of automated document-to-document and/or document-to-entity matching using machine learning models.

### Background Art

Paperwork or document management is a burden across several industries and business. As documents continue to be digitized, there becomes an increasing issue with classifying paper documents and harmonizing those documents with other paper documents and digital documents. For example, difficulties arise when trying to categorize a particular document with associated documents pertaining to a particular entity or project.

An example of this arises in the transportation industry and with trucking carriers. Trucking carriers may receive a large number of documents on a daily basis. For example, at an estimate of 4 documents per truck per day, a trucking company managing 100 trucks will receive and sort 400 documents per day. These documents may be received from various communication and technological channels which adds an additional layer of complexity when sorting and managing such documents. For example, the documents may be received from email, fax, paper mail, text message, SMS message, third party application programming interfaces (APIs), web or mobile-application uploads, shared physical memory drives, and/or other sources of document delivery. Managing, organizing, and storing such documents becomes complex when such documents are received from different channels. Additionally, identifying the particular truck, delivery contract, and/or entities associated with the delivery is also challenging.

Despite attempts to automate document review and management, such attempts struggle with addressing the disparate channels of receiving such documents as well as with poor quality versions of documents. For example, a submitted document may be a poor quality image of the document. Harmonizing documents received in different formats and received via different sources has therefore hindered the various industries and has led to inefficient document management processes.

### BRIEF DESCRIPTION OF THE DRAWINGS

The accompanying drawings are incorporated herein and form a part of the specification.

FIG. 1 depicts a block diagram of a document matching environment, according to some embodiments.

FIG. 2A depicts a diagram of a graphical user interface identifying a matched document, according to some embodiments.

FIG. 2B depicts a diagram of a graphical user interface identifying data fields of a matched document, according to some embodiments.

FIG. 3A depicts a flowchart illustrating a method for identifying a matching document, according to some embodiments.

FIG. 3B depicts a flowchart illustrating a method for identifying a matching document using match thresholds corresponding to common data fields, according to some embodiments.

FIG. 3C depicts a flowchart illustrating a method for identifying a matching document using a quantity of matching character strings, according to some embodiments.

FIG. 4A depicts a flowchart illustrating a method for identifying a matching data structure, according to some embodiments.

FIG. 4B depicts a flowchart illustrating a method for identifying a matching data structure using match thresholds corresponding to common data fields, according to some embodiments.

FIG. 4C depicts a flowchart illustrating a method for identifying a matching data structure using a quantity of matching character strings, according to some embodiments.

FIG. 5A depicts a flowchart illustrating a method for generating a graphical user interface identifying a matching document, according to some embodiments.

FIG. 5B depicts a flowchart illustrating a method for generating a graphical user interface identifying a matching data structure, according to some embodiments.

FIG. 5C depicts a flowchart illustrating a method for generating a graphical user interface ranking one or more documents and/or data structures, according to some embodiments.

FIG. 5D depicts a flowchart illustrating a method for transmitting an identification of one or more matching documents and/or data structures via an API, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for automatically categorizing and matching documents using machine learning.

In some embodiments, a document matching system applies one or more machine learning processes to a document to identify matching documents and/or data structures. For example, the document matching system may consider a first document and a second document and determine whether the first document is associated with a second document. The first document may be a different type of document relative to the second document. For example, the first document may be a contract or specification of a delivery while the second document may be a receipt indicating execution of the contract or completion of the delivery. In this manner, the first and second document may not be identical. Rather, the document matching system determines whether the first and second documents are associated with the same project, entity, and/or other organizational concept that is common to both documents. The identification of such an association may be referred to as a match or determining that the first and second documents are matching.

To perform the matching, the document matching system may classify the first and second documents using a first machine learning process to determine their respective document types. The document matching system may then extract character strings from the first and second documents and compare the character strings to determine whether there are matching character strings between the first and second documents. As further explained below, this comparison may account for near-matches or fuzzy matching dependent on the type of data field corresponding to the particular character strings being compared. Based on the identification of matching character strings, the document matching system may determine whether the first and second document match.

In some embodiments, the comparison may be performed using a second machine learning process. The second machine learning process may generate a probability of match between the first and second documents based on character strings extracted from the first document and text from the second document. In some embodiments, text from the second document may be further parsed prior to application to the second machine learning process. For example, character strings from the second document may be extracted based on a match threshold and these extracted values may be applied to the second machine learning process to determine the probability of match. In some embodiments, a quantity of matching character strings may be determined and used to determine whether the first and second documents match. For example, a cosine similarity may be measured between the pair of documents.

Based on the comparison, the document matching system may determine whether the first and second document match based on a probability of match produced by the second machine learning process and/or based on a comparison of a quantity of matching character strings. When either of these values exceed a threshold, the document matching system may designate the documents as matching.

As further explained below, the document matching system may also match a document to a data structure and/or a data object. For example, a data structure may include data fields with corresponding data values identifying a project, entity, and/or other organizational concept. For example, in the trucking and delivery context, a data structure may correspond to a particular delivery and/or one or more documents corresponding to that particular delivery. The data fields of the data structure may include a pickup address, pickup date, pickup time, delivery address, expected delivery date, expected delivery time, actual delivery date, actual delivery time, recipient information, weight of load, driver name, and/or other data fields relevant to the data structure. Using the techniques described herein, the document matching system may identify a data structure matching a particular document. In some embodiments, the document matching system may identify one or more documents matching a particular data structure.

In some embodiments, the document matching system may also match multiple documents. For example, given a particular document, the document matching system may identify multiple matching documents and/or potentially matching documents. For example, the document matching system may compare the document to multiple potentially matching documents. The document matching system may perform this comparison using a machine learning process as further described below. This may produce corresponding match probabilities for each of the potentially matching documents. The document matching system may then identify and/or return one or more of these potentially matching documents. For example, the document matching system may implement a matching threshold and may identify one or more documents exceeding the matching threshold as potential matches. In some embodiments, the document matching system may identify a ranking of one or more documents based the respective probabilities of match. The document matching system may implement the ranking with or without the threshold. In some embodiments, the document matching system may also assign a qualitative value based on the probability of match. For example, the document with the greatest probability may be assigned a “match” designation while other documents may be assigned a “high” or “low” designation. When identifying a data structure corresponding to a document, the document matching system may also identify multiple documents already associated with that data structure.

To identify one or more matching documents, the document matching system may generate a graphical user interface (GUI) displaying one or more matching documents. For example, when a document is identified, the GUI may display an image and/or visual data object displaying the document. The GUI may also include one or more colors highlighting portions of the image and/or visual data object. This highlighting may identify the data fields and/or character strings used to determine the probability of a matching document. In some embodiments, the GUI may simultaneously display an image of a submitted document along with an identified document. The GUI may apply the color highlighting to both images to identify the data values that are shared. This may aid a user in visualizing the matching character strings and/or provide an explanation for the machine learning process to explain why the machine learning process arrived at its result. The GUI may also provide a visualization of ranking the one or more identified documents.

In some embodiments, the document matching system may interface with a client system. The document matching system may receive one or more documents from the client system to identify matching documents and/or data structures. For example, the client system may provide the document matching system with a first and second document. This may be provided to the document matching system via an application programming interface (API). The document matching system may then apply one or more machine learning processes to determine whether the first and second document match. The document matching system may then return the determination via the API.

The client system may define a data structure and/or include one or more documents corresponding to that data structure. For example, a defined data structure may correspond to a particular delivery contract or job. The documents may correspond to paperwork for that delivery contract or job. The client system may then provide another document to the document matching system. For example, this document may correspond to a receipt indicating completion of delivery. The document matching system may then identify the data structure and/or the one or more documents corresponding to that data structure based on the received document. The document matching system may then store and/or associate the received document with the previously defined data structure after performing the automated matching. In this manner, the document matching system may automate the recognition, management, and/or organization of received documents with corresponding data structures and/or other documents. In some embodiments, the document matching system may provide the indication to the client system to inform the client system and to allow the client system to manage the document associations.

In the example of the trucking industry, the document matching system may be implemented to manage documents related to a particular delivery, job, and/or shipment contract. For example, a particular shipment contract may be referred to as a rate confirmation. A client system may store a rate confirmation as a document and/or as a data structure. In some embodiments, information within the rate confirmation may be entered as structured fields in a Transportation Management System (TMS). Upon completion of the contract and/or delivery of a truck's load, the client system and/or the document management system may receive one or more documents indicating a proof of delivery. The one or more documents may include a bill of lading, load pictures, and/or additional charge documents. These documents may be received via various channels. For example, the documents may be received from email, fax, paper mail, text message, SMS message, third party application programming interfaces (APIs), web or mobile-application uploads, shared physical memory drives, and/or other sources of document delivery. The document matching system may receive and/or process these documents to identify a matching document and/or data entity. For example, for a received bill of lading, the document matching system may identify the corresponding rate confirmation using the machine learning techniques described below. In some embodiments, the document matching system may identify a data structure corresponding to the delivery and store the bill of lading with the rate confirmation. This automated storage and/or association may allow for invoice issuance. Additionally, the automation of this document processing may provide computational efficiencies by avoiding manual data entry and/or the many computational interactions used to manually organize such documents. In this manner, the document matching system may automate the matching and association of documents with other documents and/or data structures.

Similarly, the document matching system may be used to maintain business documents that are entity-based. For example, in the trucking industry, an entity may be a truck driver. The document matching system may identify the truck driver using a particular data structure. The document matching system may then use the machine learning processes described herein to associate documents with the data structure. For example, such documents may include driver identification documents, a driver's license, motor vehicle records, a social security number card, a passport copy, a medical card, a drug test result, traffic tickets, driver recruitment documents, employment documents, safety management documents, and/or other driver-related documents which may be indicated by a government regulation or by an agency such as the Department of Transportation. Another example of an entity-based data structure may be a data structure corresponding to equipment. This equipment may include trucks and/or trailers. The documents may include registration records, reports, maintenance records, repair invoices, and/or other documents related to equipment. The document matching system may maintain and/or organize such documents for audit compliance and/or to track document expirations. The document matching system may manage such documents using entity-based data structures.

The document matching system may also provide verification for documents. For example, the document matching system may identify a measure of legitimacy and/or accuracy for a given document. This verification may confirm that a particular document correctly corresponds to another document and/or that the particular document that is sought after actually exists. For example, the verification may confirm that a bill of lading matches a rate confirmation or that a medical evaluation document matches a particular truck driver. In some embodiments, the verification may be provided by a verification score that may correspond to the probability of match. The document matching system may provide such a verification score to a workflow or subsequent process to continue document processing.

For example, a particular workflow may be to determine whether an invoice is accurate and/or valid based on a determination of whether a bill of lading matches a rate confirmation. The document matching system may compare the two documents and provide a numerical value indication of a probability of match or degree of match as further discussed below. This value may provide a verification of match. For example, when the value exceeds a particular threshold, the document matching system may verify the documents as matching. In some embodiments, the document matching system may provide an indication verifying the documents as matching and/or provide the value or score to a system for further processing. With the verification, a system or workflow may proceed with additional document processing. For example, with the verification, the system may automatically proceed with initiating an invoice payment.

This verification may also apply to freight audit workflows. For example, when a probability of match or a verification score falls below a threshold, the document matching system may indicate that the documents do not match. In some instances, this may occur when there are errors in the documents. While the documents should match, the errors may result in a lower probability of match. The document matching system may provide such an indication. This may be used to flag and/or correct erroneous documents. In the freight audit context, this may be used to correct errors with invoice, bill of lading, and/or rate confirmation documents.

While examples have been described with reference to the trucking industry, the document matching system may also be applied in other industries, contexts, or use cases. For example, in the medical industry documents may be matched or associated with other documents corresponding to a patient or a medical procedure. Similarly, in the legal context, documents may be matched to a particular legal proceeding or dispute. While the trucking industry is provided as an example, the disclosure and the functionality of the document matching system is not limited to solely the trucking industry.

Various embodiments of these features will now be discussed with respect to the corresponding figures.

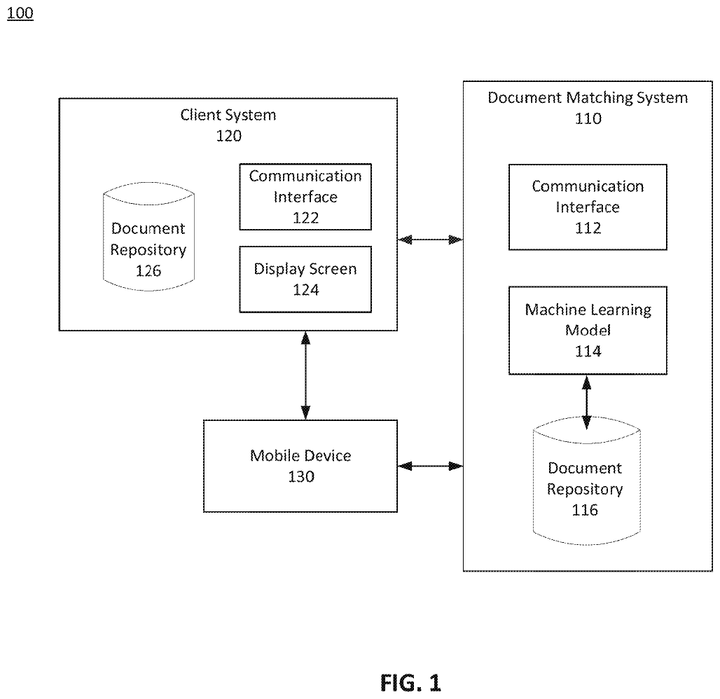

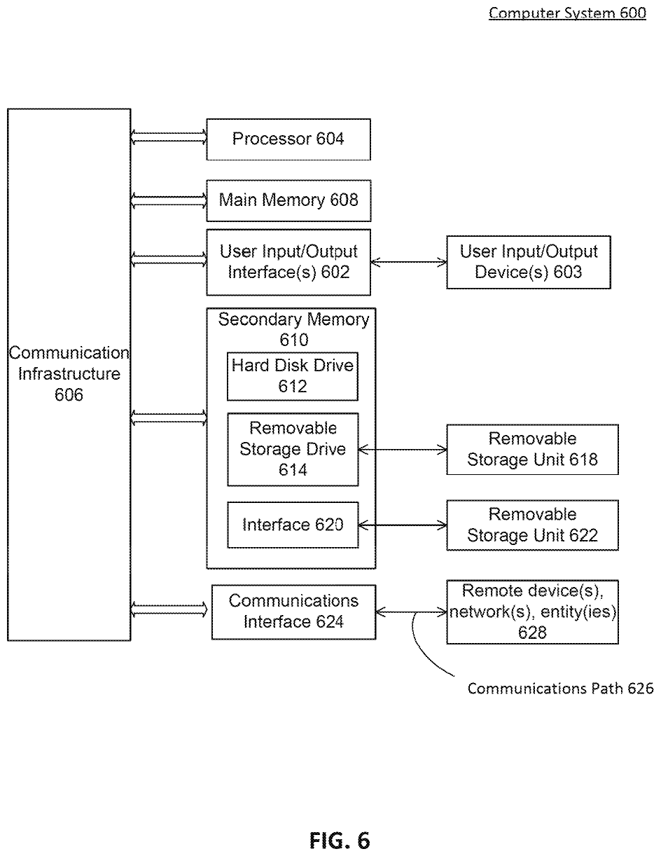

FIG. 1 depicts a block diagram of a document matching environment 100, according to some embodiments. Document matching environment 100 may include document matching system 110, client system 120, and/or mobile device 130. Document matching system 110, client system 120, and/or mobile device 130 may be implemented using computer system 600 as further described with reference to FIG. 6.

For example, document matching system 110 may be implemented using one or more servers and/or databases. Document matching system 110 may communicate with one or more client systems 120 and/or mobile devices 130 over a network. The network may include any combination of wired and/or wireless networks, which may include mobile communication networks, Local Area Networks (LANs), Wide Area Networks (WANs), and/or the Internet. Document matching system 110 may use communication interface 112 to perform this communication. Communication interface 112 may interface with these networks to implement bidirectional communications with one or more client systems 120 and/or mobile devices 130. In some embodiments, communication interface 112 may be an application programming interface (API) used for communications with client system 120 and/or mobile device 130. Communication interface 112 may also include a mobile communication network interface capable of receiving and/or sending text, SMS, and/or MMS messages. For example, communication interface 112 may receive text, SMS, and/or MMS messages from mobile device 130. In some embodiments, document matching system 110 may receive one or more documents via communication interface 112. Document matching system 110 may also provide an indication of a matching document and/or data structure via communication interface 112.

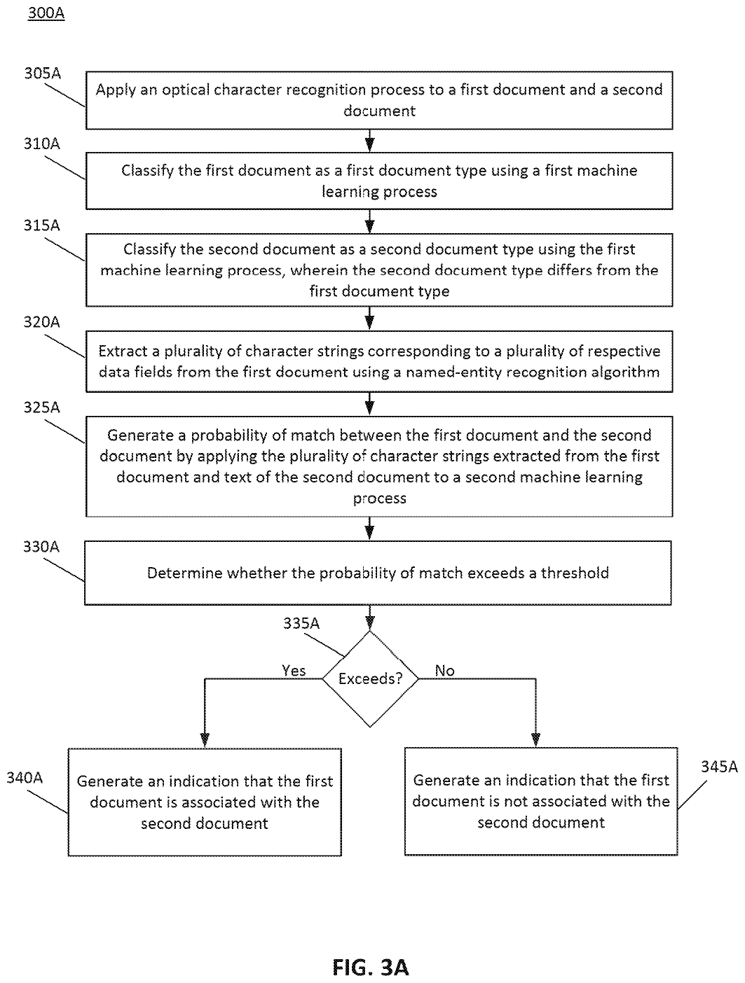

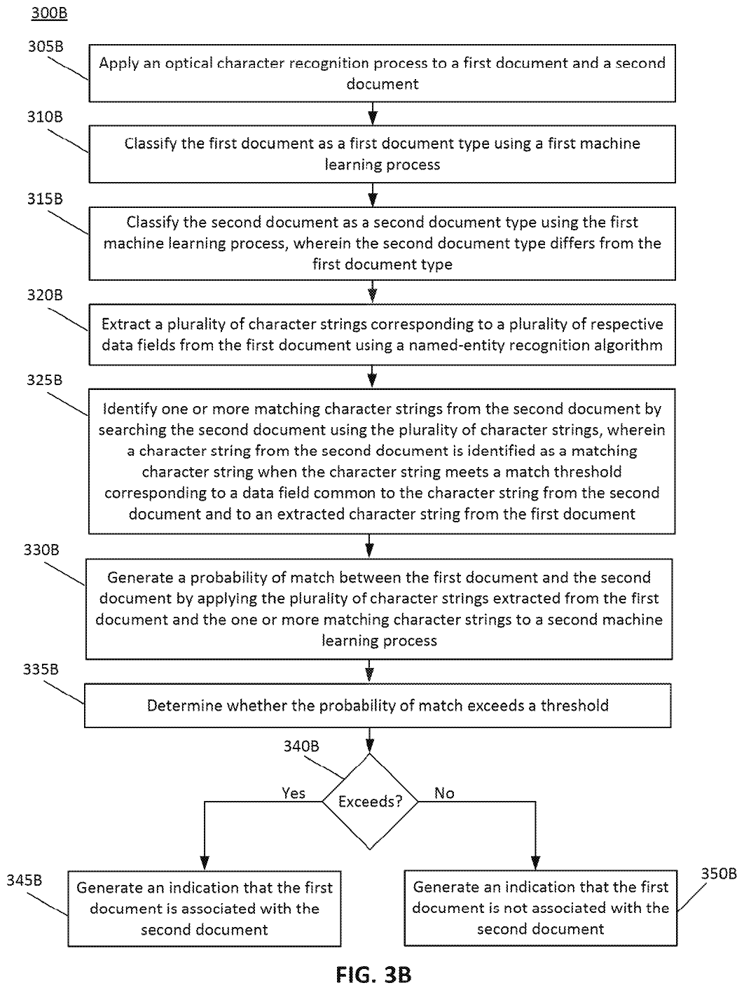

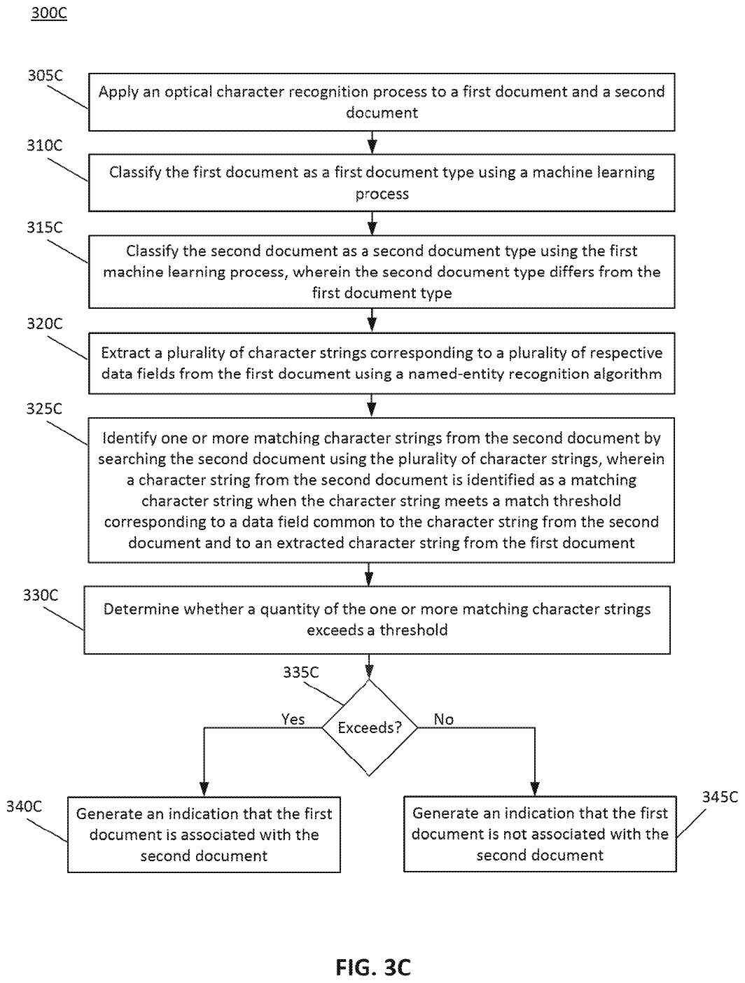

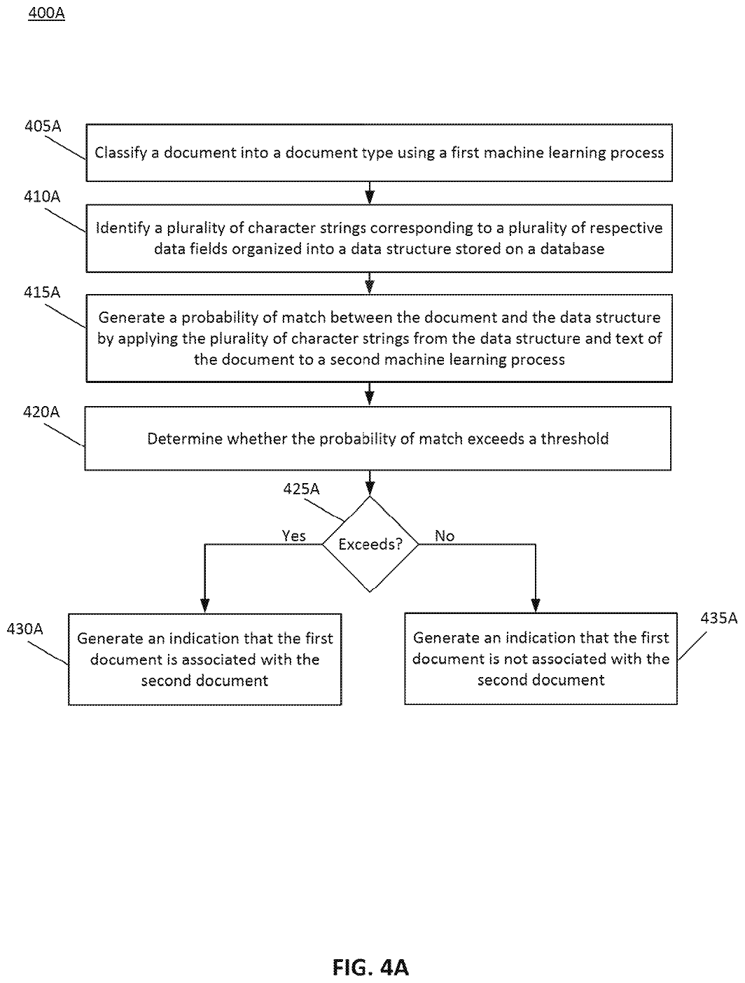

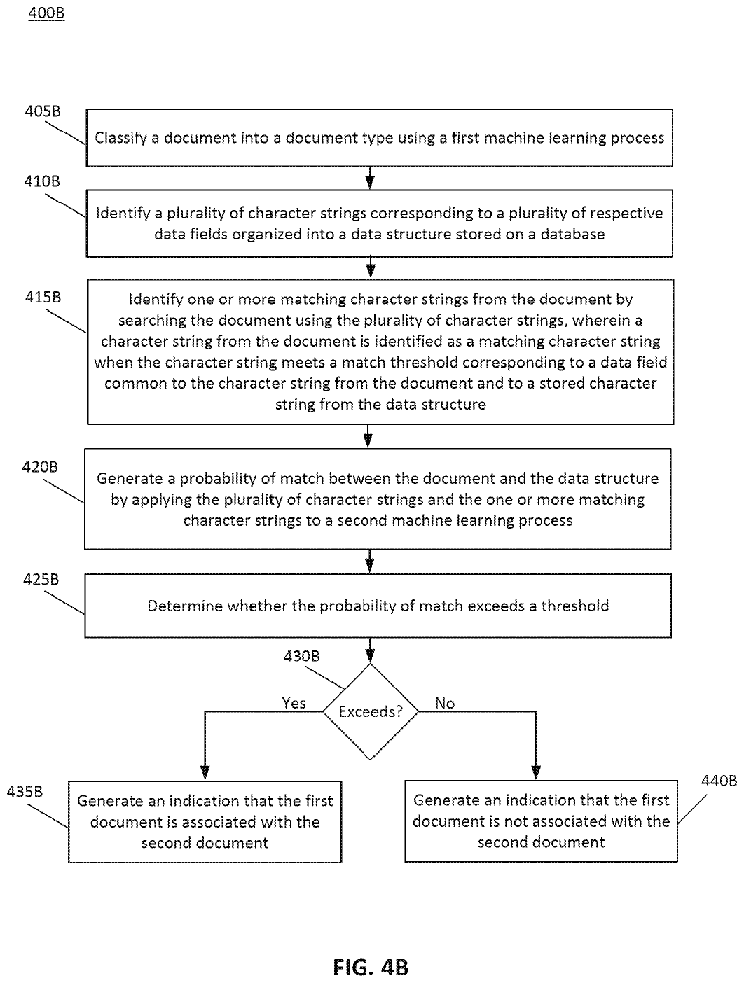

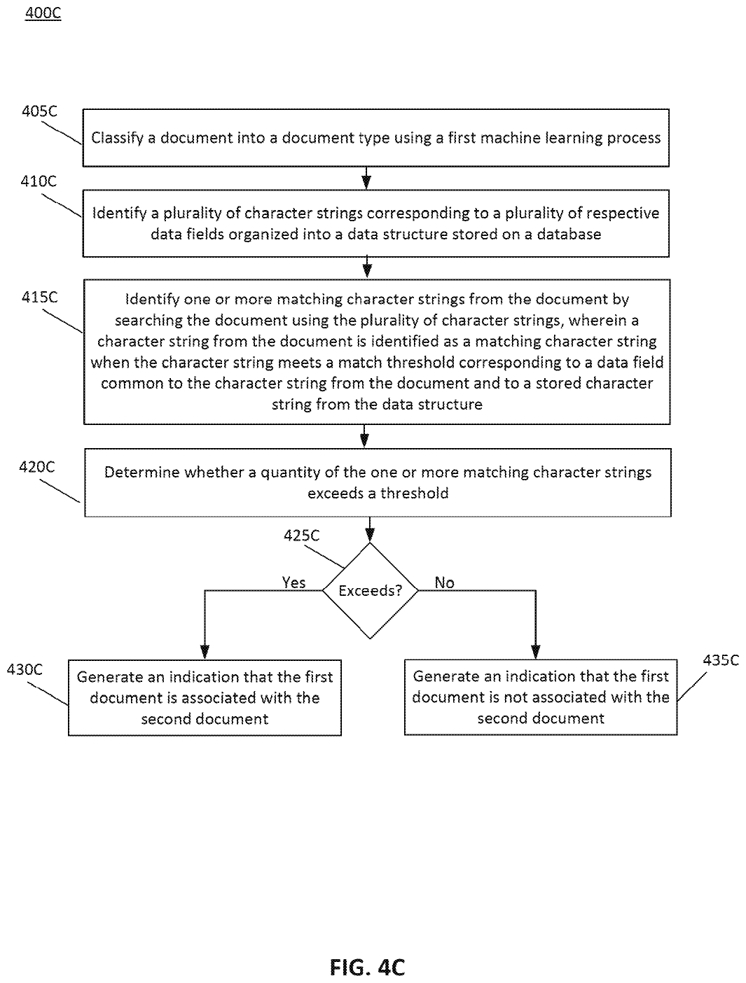

Document matching system 110 may also include machine learning model 114. Machine learning model 114 may implement one or more machine learning process as discussed herein to perform document matching. This may include document-to-document matching and/or document-to-entity matching via a data structure. For example, machine learning model 114 may implement one or more of the processes described with reference FIGS. 3A-3C, 4A-4C, and/or 5A-5D. Document matching system 110 may return results generated by machine learning model 114 to client system 120. In some embodiments, document matching system 110 may generate one or more GUIs that may be provided to client system 120 for display via display screen 124.

Document matching system 110 may also include document repository 116. Document repository 116 may be a database and/or memory. Document repository 116 may store documents, data structures, and/or associates between documents and/or data structures. For example, the associations may be database entries. Client system 120 and/or mobile device 130 may provide documents to document matching system 110 for storage in document repository 116. Similarly, client system 120 and/or mobile device 130 may specify and/or define data structures which may be stored in document repository 116. The data structure may also be associated with one or more documents. Client system 120 and/or mobile device 130 may specify data fields, data entries, and/or character strings for each data structure.

Turning to client system 120, client system 120 may include communication interface 122, display screen 124, and/or document repository 126. Communication interface 122 may be similar to communication interface 112. Client system 120 may use communication interface 112 to communicate with document matching system 110 and/or mobile device 130. For example, client system 120 may receive one or more documents from mobile device 130 via communication interface 112. Client system 120 may provide one or more documents to document matching system 110 using communication interface 122. These documents may be stored in document repository 126 and then transmitted to document matching system 110.

In some embodiments, client system 120 may provide a first document and a second document to document matching system 110. Document matching system 110 may determine whether the first document matches the second document. Document matching system 110 may then return this determination and/or a probability of match to client system 120.

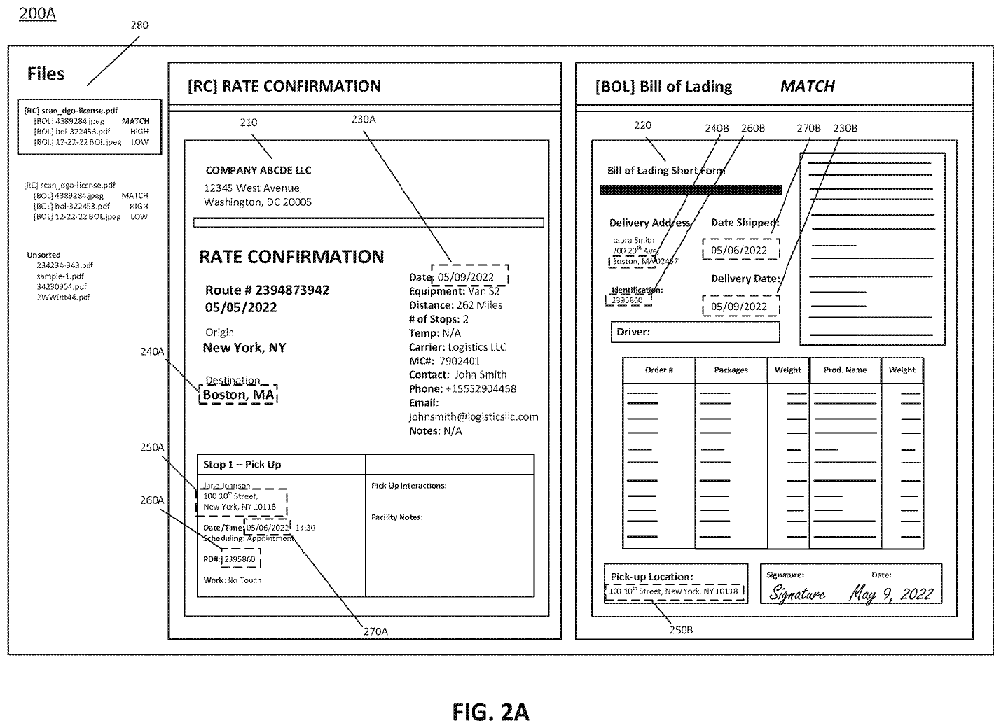

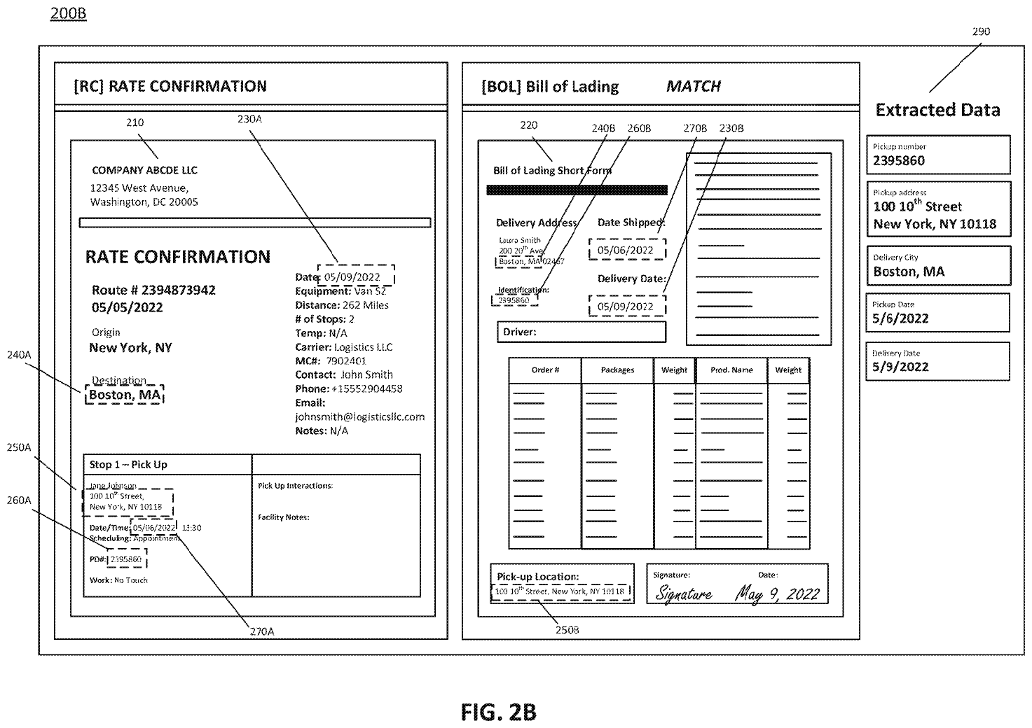

In some embodiments, client system 120 may provide multiple documents to document matching system 110 for document management. Document matching system 110 may store these documents in document repository 116. The documents may be organized into data structures as specified by client system 120. Client system 120 may subsequently provide another document to document matching system 110 for matching with the previously stored documents and/or data structures. For example, document matching system 110 may identify one or more matching documents and/or data structures as further described below. Document matching system 110 may store the received document with an association to the one or more matching documents and/or to one or more identified data structures. Document matching system 110 may also provide an indication of the identified documents and/or data structures to client system 120. For example, document matching system 110 may provide GUI data that may be instantiated by client system 120 and displayed on display screen 124. Example GUIs are further described with reference to FIGS. 2A and 2B.

FIG. 2A depicts a diagram of a graphical user interface (GUI) 200A identifying a matched document, according to some embodiments. Data used to instantiate and/or display GUI 200A may be generated by document matching system 110. This data may be provided to client system 120 for use in displaying GUI 200A via display screen 124. Document matching system 110 may generate GUI 200A to indicate one or more matching documents and/or a rank corresponding to the identified potentially matching documents.

For example, GUI 200A may include a first document 210 and/or a second document 220. First document 210 and/or second document 220 may have been provided to document matching system 110 by client system 120. For example, client system 120 may have provided first document 210 together with second document 220 or at separate points in time. After document matching system 110 has determined whether the first document 210 matches the second document 220, document matching system 110 may generate the data displayed in GUI 200A to indicate a match.

As further explained below, document matching system 110 may classify the first document 210 and/or second document 220 into respective document types. Document matching system 110 may implement a document classification machine learning process to classify a document into a particular document type. A document type may be a predefined document classification identified based on the training applied to the document classification machine learning process. Document matching system 110 may implement rules-based matching based on document type to generate associations and/or links between documents and/or data structures. For example, in the trucking industry, first document 210 may have a document type corresponding to a rate confirmation. Second document 220 may have a document type corresponding to a bill of lading. Document matching system 110 may implement a rule associating bill of lading type documents with rate confirmation documents. This rule may reflect the association and/or link between the two types of documents. For example, this may indicate that the document types are complements of each other.

Returning to first document 210 and second document 220, after determining that their respective document types suggest a linkage, document matching system 110 may identify respective data fields and/or matching character strings to determine a probability of a match. As further explained below, this matching may be a near-matching and/or fuzzy matching process dependent on the type of data field. For example, when the type of data field is a date, the fuzzy matching may provide an allowance or tolerance of a number of days difference. In the trucking industry, a rate confirmation may indicate a particular delivery date but the bill of lading may indicate an actual delivery date with a one day delay. Document matching system 110 may still identify such dates as matching due to the proximity of the date falling within a particular threshold. This determination may be made due to the data field being a date type data field. This may also account for different date formats.

Similarly, another type of data field may depend on a number of matching characters in a character string. For example, for a name, document matching system 110 may identify a match based on a number of matching characters meeting a threshold. This may account for misspellings and/or short hand names. Document matching system 110 may still identify such character strings as matching. In some embodiments, a data field may correspond to a particular geographical location. Document matching system 110 may identify character strings that are matching. In some embodiments, document matching system 110 may set a threshold based on a geographical proximity for the address. Addresses falling within a threshold of geographical proximity may be considered as matching. As will be further explained below, the comparison of such fields may be performed via a machine learning process to identify a probability of match between first document 210 and second document 220.

Returning to GUI 200A, document matching system 110 may have determined that first document 210 matches second document 220 based on their respective documents types and/or a probability of match based on an applied machine learning process. GUI 200A may display first document 210 and second document 220 with a designation that they match. For example, second document 220 may have the highest probability of match relative to other documents and/or other documents having the same document type as second document 220. Based on the match probability, document matching system 110 may identify second document 220 as having the highest probability of matching first document 210. In some embodiments, GUI object 280 may identify one or more documents as potential matches. For example, this may be a ranking and/or may include qualitative descriptors of potentially matching documents. This may allow users to select, view, and/or browse other documents that may be potentially matching.

GUI 200A may also identify data fields and/or character strings that match between first document 210 and second document 220. This may account for near-matches and/or fuzzy matches. GUI 200A may highlight portions of documents and/or portions of document images to identify these character strings. Different colored highlighted may indicate different data fields. For example, highlighting 230A may highlight a portion of the first document 210 indicating a date. Highlighting 230B may also identify that date in second document 220. The same color may be used for highlighting 230A and 230B.

Similarly, highlighting 240A may identify a city and state in first document 210 while highlighting 240B may identify the city and state in second document 220. The same color may be used for highlighting 240A and 240B. This color, however, may be different from the color used for highlighting 230A and 230B. For example, highlighting 230A, 230B may be blue to indicate the date while highlighting 240A, 240B may be red to highlight the city and state. This pattern of matching highlighting between first document 210 and second document 220 may also be applied to the other highlighting pairs and highlighting 250A, 250B, 260A, 260B, 270A, and 270B.

As further explained below, first document 210 and second document 220 may have different image qualities. For example, first document 210 may be a high quality scan, PDF, and/or text document from a word processing application while second document 220 may be a poorer quality image. For example, second document 220 may be an image of a document captured by mobile device 130. Document matching system 110 may handle both types of image qualities and/or may apply highlighting to the identified portions of document images as well to identify respective data fields identified as matches. In some embodiments, document matching system 110 may apply an optical character recognition (OCR) process to first document 210 and/or second document 220. Document matching system 110 may identify characters and/or bounding boxes for groups of characters using the OCR process. This character position information may be used for highlighting the identified matching character strings. This may also account for poorer quality images and still explain and identify to a user the portions of the image detected (or not detected due to lack of highlighted) as matches. In this manner, document matching system 110 may process poor quality documents and still identify potentially matching character strings with higher quality documents.

FIG. 2B depicts a diagram of a graphical user interface (GUI) 200B identifying data fields of a matched document, according to some embodiments. Similar to GUI 200A, document matching system 110 may generate data used by a client system 120 to display GUI 200B. Document matching system 110 may have determined that first document 210 matches second document 220. Based on this matching, GUI 200B may include highlighting 230A, 230B, 240A, 240B, 250A, 250B, 260A, 260B, 270A, and 270B in a manner similar to that described with reference to GUI 200A. This highlighting may indicate data fields common to both the first document 210 and the second document 220.

GUI 200B may also include a GUI object 290, which may identify the data fields corresponding to the highlighting. For example, GUI object 290 may display the data fields, data values, and/or character strings identified as matching between first document 210 and second document 220. GUI object 290 may also be color-coordinated with the respective highlighting 230A, 230B, 240A, 240B, 250A, 250B, 260A, 260B, 270A, and 270B of the data fields as well. For example, if highlighting 230A and 230B are blue to indicate the date, GUI object 290 may also highlight the extracted date data field and/or data value with blue. This configuration allows a user to quickly view the extracted data field and/or value identified by the machine learning process used to compare and match the first document 210 and the second document 220. With the same highlighting color, the user is also able to quickly view where the data field is located within the first document 210 and/or the second document 220. This provides an explanation for how the machine learning process determined that the first document 210 matches the second document 220.

FIG. 3A depicts a flowchart illustrating a method 300A for identifying a matching document, according to some embodiments. Method 300A shall be described with reference to FIG. 1; however, method 300A is not limited to that example embodiment.

In an embodiment, document matching system 110 may utilize method 300A to determine whether a first document matches a second document. The foregoing description will describe an embodiment of the execution of method 300A with respect to document matching system 110. While method 300A is described with reference to document matching system 110, method 300A may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3A, as will be understood by a person of ordinary skill in the art.

At 305A, document matching system 110 may apply an optical character recognition (OCR) process to a first document and a second document. The OCR process may identify characters and/or bounding boxes corresponding to text in the first and second documents. In some embodiments, the OCR process may be optional. For example, when document matching system 110 receives the first and/or second document, client system 120 may have already applied an OCR process and/or identified character information. In some embodiments, an OCR process may be avoided when the first and/or second document is a word processing document or file format.

At 310A, document matching system 110 may classify the first document as a first document type using a first machine learning process. At 315A, document matching system 110 may classify the second document as a second document type using the first machine learning process, wherein the second document type differs from the first document type. The first machine learning process may correspond to a machine learning model that may have been trained to classify a document. This training may have been performed in a supervised manner. During training, a set of document examples corresponding to each document type of interest may have been applied to the first machine learning process to train the first machine learning process to classify document. In some embodiments, the first machine learning process may use algorithms including pre-trained transformer fine-tuning, a Bidirectional Encoder Representations from Transformers (BERT) model, a bag of words classifier, a support vector machine (SVM) algorithm, and/or other language classification models. In some embodiments, the first machine learning process may be considered a document classifier.

Based on the training of the first machine learning process, the first machine learning process may determine the respective document types for first document and the second document. For example, in the trucking industry context, the first document may correspond to a rate confirmation while the second document may correspond to a bill of lading. Based on its training, the first machine learning process may classify each document accordingly. As previously discussed, the document matching system 110 may additionally apply a matching rule to link or associate documents and/or data structures. For example, a rule may be to associate documents having a rate confirmation document type with documents having a bill of lading document type. In some embodiments, the document matching system 110 extracts information from the rate confirmation document, stores it in the data repository 116, and then subsequently identifies the matching rate confirmation for a received bill of lading. In this manner, document matching system 110 may automate and/or enhance the matching of documents.

At 320A, document matching system 110 may extract a plurality of character strings corresponding to a plurality of respective data fields from the first document using a named-entity recognition (NER) algorithm. Document matching system 110 may apply the NER algorithm based on the first document corresponding to the first document. For example, the NER algorithm may have been trained for corresponding document types of interest. The first document type may have been designated as a type of document corresponding to the NER algorithm training. The NER algorithm may have been trained using a training user interface and/or by importing pre-extracted document fields from a CSV file. Key data fields of interest via document category annotation schemas may have also been defined. The trained NER algorithm would then extract character strings corresponding to these data fields.

In some embodiments, the first document type may be a rate confirmation. The NER would have been trained to extract character strings corresponding to particular data fields in rate confirmation type documents. In view of the document matching system 110 classifying the first document as a rate confirmation, the document matching system 110 would have then applied the NER algorithm to extract character strings corresponding to respective data fields. In some embodiments, the NER algorithm may have been used based on the quality associated with the first document type. For example, rate confirmation documents may have a visually higher quality relative to a bill of lading quality. Because of this higher quality, an NER algorithm may more accurately extract relevant character strings. Similarly, a rate confirmation may include less errors and be more applicable to an NER algorithm as well. For example, a rate confirmation document may be considered a source of truth in a contract management system. In view of this understanding, in some embodiments, document matching system 110 may apply the trained NER algorithm to the rate confirmation document, store the extracted plurality of character strings and respective data fields in data repository 116, and then subsequently identifies the matching rate confirmation for a received bill of lading using the plurality of character strings.

At 325A, document matching system 110 may generate a probability of match between the first document and the second document by applying the plurality of character strings extracted from the first document and text of the second document to a second machine learning process. The second machine learning process may be document pair classification which may be more resilient to errors by avoiding potential per-field error accumulation. In some embodiments, the text from the second document may be a portion of the second document or the full text of the second document. The text may be applied to the second machine learning process with separators. The second machine learning process would have been previously trained to produce a probability output based comparison training data. This may be a numerical value produced based on the training.

At 330A, document matching system 110 may determine whether the probability of match exceeds a threshold. For example, the threshold may be preconfigured in document matching system 110. An example threshold may be an 80% match. Document matching system 110 may compare the value output by the second machine learning process with this threshold. At 335A, document matching system 110 may determine whether the output meets or exceeds the threshold. In some embodiments, exceeding the threshold may be considered as satisfying a threshold condition and may not necessarily require identifying the probability as greater than the threshold.

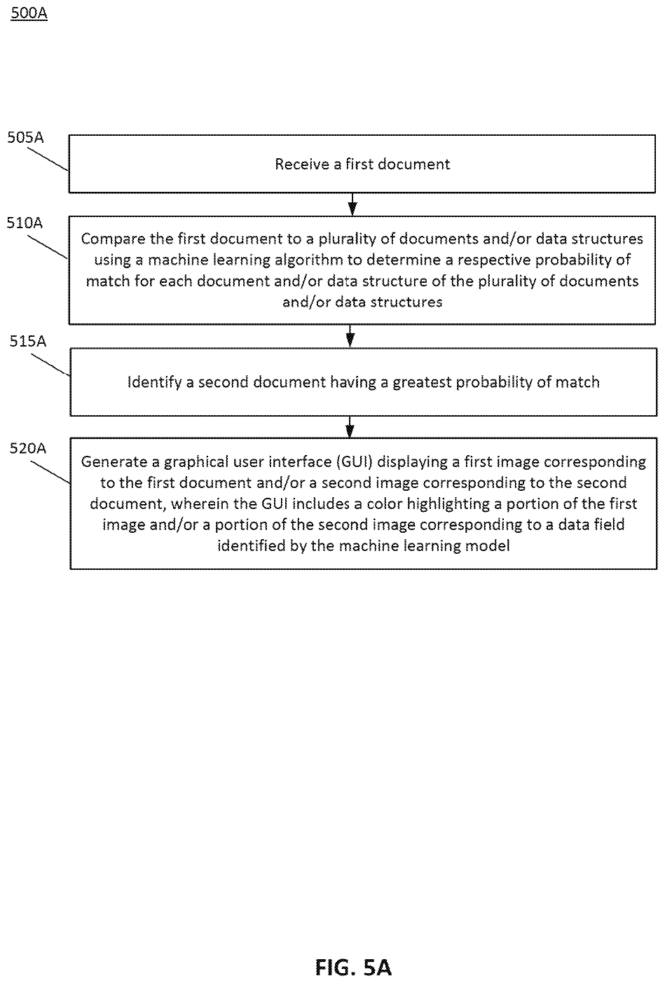

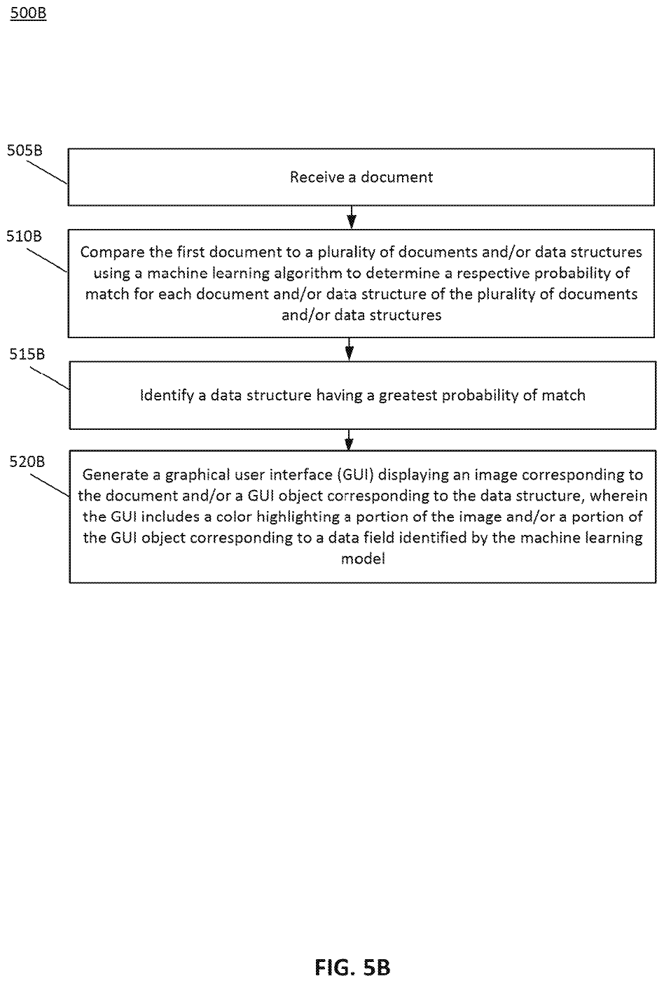

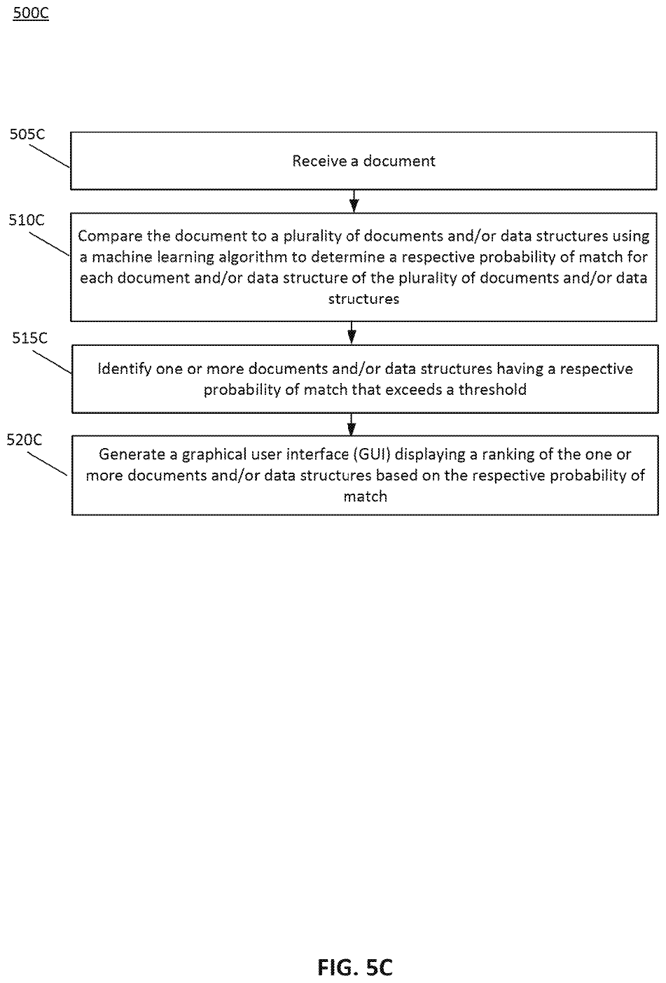

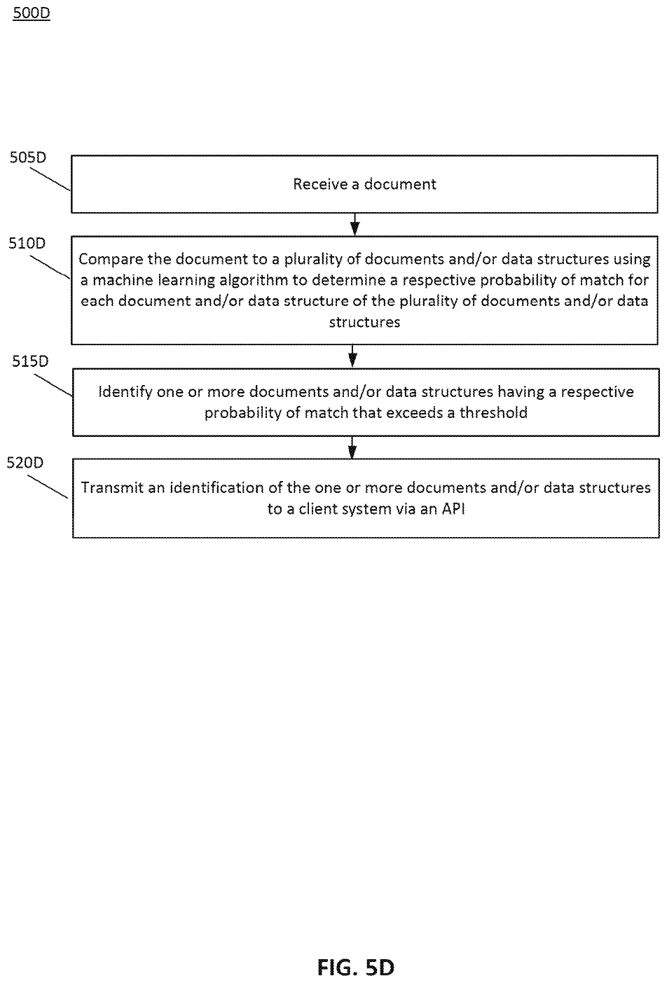

At 340A, if the probability of match exceeds the threshold, document matching system 110 may generate an indication that the first document is associated with the second document. At 345A, if the probability of match does not exceed the threshold, document matching system 110 may generate an indication that the first document is not associated with the second document. For example, this indication may be in the form of a GUI and/or GUI object as described with reference to FIGS. 2A-2B. Other example indications are further described with reference to FIGS. 5A-5D. For example, document matching system 110 may inform client system 120 of the determination via GUI data and/or via an API. Client system 120 may update its records based on the determination provided by document matching system 110. While method 300A describes the comparison of a first and second document, document matching system 110 may also describe the comparison with a data structure representing an entity and/or multiple documents as further described below.

In some embodiments, the indication provided at 340A and/or 345A may be a verification of whether the first document verifies the second document and/or whether the second document verifies the first document. For example, the indication may be a verification score and/or the probability of match. This value may be provided to client system 120 to continue with additional workflows. For example, when a rate confirmation is determined to match a bill of lading, the indication may verify the match. Client system 120 may receive this indication of verification and may perform additional actions. For example, client system 120 may automatically initiate the payment of an invoice. In situations where the document matching system 110 determines that the documents do not match, this indication may also be provided to client system 120. Client system 120 may then perform an audit based on the indication. For example, the indication that the documents do not match may indicate an error in one or both of the documents. Client system 120 may then appropriately correct such errors. This may occur, for example, when performing a freight audit workflow process. This process may be automated based on the result returned by document matching system 110.

In some embodiments, the threshold determination at 330A may be optional. For example, document matching system 110 may transmit the probability of match to client system 120 as a value. This value may indicate a verification score between the two documents. Client system 120 may perform further processing using such a verification score. For example, client system 120 may use its own threshold values to determine whether the received value indicates a match. This may be useful in freight audit scenarios as previously explained. In some embodiments, client system 120 may rely on document matching system 110 to provide this determination based on the threshold described in 330A. In this case, document matching system 110 may provide a quantitative and/or a qualitative indication of whether the first document is associated with the second document at 340A and/or 345A.

In some embodiments, document matching system 110 may also use a feedback loop to continue to train the machine learning processes used in method 300A. For example, document matching system 110 may re-train the first machine learning process, the NER algorithm, and/or the second machine learning process. This may occur when a user has supplied additional training data and/or has reviewed and/or edited results generated from execution of method 300A.

FIG. 3B depicts a flowchart illustrating a method 300B for identifying a matching document using match thresholds corresponding to common data fields, according to some embodiments. Method 300B shall be described with reference to FIG. 1; however, method 300B is not limited to that example embodiment.

In an embodiment, document matching system 110 may utilize method 300B to determine whether a first document matches a second document. The foregoing description will describe an embodiment of the execution of method 300B with respect to document matching system 110. While method 300B is described with reference to document matching system 110, method 300B may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3B, as will be understood by a person of ordinary skill in the art.

At 305B, document matching system 110 may apply an optical character recognition (OCR) process to a first document and a second document. At 310B, document matching system 110 may classify the first document as a first document type using a first machine learning process. At 315B, document matching system 110 may classify the second document as a second document type using the first machine learning process, wherein the second document type differs from the first document type. At 320B, document matching system 110 may extract a plurality of character strings corresponding to a plurality of respective data fields from the first document using a named-entity recognition (NER) algorithm. The processes for 305B, 310B, 315B, and 320B may be similar to those described with reference to 305A, 310A, 315A, and 320A respectively.

At 325B, document matching system 110 may identify one or more matching character strings from the second document by searching the second document using the plurality of character strings extracted from the first document. When identifying a matching character string, document matching system 110 may identify a character string from the second document as a matching character string when the character string meets a match threshold corresponding to a data field common to the character string from the second document and to an extracted character string from the first document.

As previously explained, this may consider near matches or fuzzy matches as matches. A match threshold may be defined for different types of relevant data fields. For example, one type of match threshold may include determining a number of matching characters when comparing character strings corresponding to a data field. For example the data field may be a recipient name. The threshold may be 80% matching characters. When data strings are compared for this data field, if 80% of the characters match, document matching system 110 may consider the strings to be matching.

Another type of data field may be a date. This match threshold may be based on date proximity. For example, the match threshold may be within two days. When comparing the character strings, if the character strings are indicate dates which are within two days of each other, document matching system 110 may consider the strings to be matching. Another type of data field may be a geographical location. For example, the match threshold may be a particular distance. When comparing the character strings, if the character strings indicate locations that are within a particular distance apart, document matching system 110 may consider the strings to be matching.

At 330B, document matching system 110 may generate a probability of match between the first document and the second document by applying the plurality of character strings extracted from the first document and the one or more matching character strings to a second machine learning process. This may occur in a similar manner to 325A described with reference to method 300A. A difference, however, may be that at 330B, the one or more matching characters strings are being applied rather than a portion or the full text from the second document.

At 335B, document matching system 110 may determine whether the probability of match exceeds a threshold. At 340B, document matching system 110 may determine whether the output meets or exceeds the threshold. At 345B, if the probability of match exceeds the threshold, document matching system 110 may generate an indication that the first document is associated with the second document. At 350B, if the probability of match does not exceed the threshold, document matching system 110 may generate an indication that the first document is not associated with the second document. The processes for 335B, 340B, 345B, and 350B may be similar to those described with reference to 330A, 335A, 340A, and 345A respectively.

FIG. 3C depicts a flowchart illustrating a method 300C for identifying a matching document using a quantity of matching character strings, according to some embodiments. Method 300C shall be described with reference to FIG. 1; however, method 300C is not limited to that example embodiment.

In an embodiment, document matching system 110 may utilize method 300C to determine whether a first document matches a second document. The foregoing description will describe an embodiment of the execution of method 300C with respect to document matching system 110. While method 300C is described with reference to document matching system 110, method 300C may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3C, as will be understood by a person of ordinary skill in the art.

At 305C, document matching system 110 may apply an optical character recognition (OCR) process to a first document and a second document. At 310C, document matching system 110 may classify the first document as a first document type using a machine learning process. At 315C, document matching system 110 may classify the second document as a second document type using the machine learning process, wherein the second document type differs from the first document type. At 320C, document matching system 110 may extract a plurality of character strings corresponding to a plurality of respective data fields from the first document using a named-entity recognition (NER) algorithm. The processes for 305C, 310C, 315C, and 320C may be similar to those described with reference to 305A, 310A, 315A, and 320A respectively.

At 325C, document matching system 110 may identify one or more matching character strings from the second document by searching the second document using the plurality of character strings extracted from the first document. When identifying a matching character string, document matching system 110 may identify a character string from the second document as a matching character string when the character string meets a match threshold corresponding to a data field common to the character string from the second document and to an extracted character string from the first document. The process for 325C may be similar to the process described with reference to 325B.

At 330C, document matching system 110 may determine whether a quantity of the one or more matching character strings exceeds a threshold. This may, for example, avoid using another machine learning process by comparing the quantity of matching character strings. In some embodiments, the comparison may be performed using a conversion of the text into vectors and measuring a cosine similarity between the pair of documents. If a predefined threshold similarity is reached, the first and second documents may be considered matching. In some embodiments, a vector representation of the documents may be achieved by limiting the document vocabulary, converting each document to a term frequency-inverse document frequency (tf-idf) weighted bag of words presentations, and/or by utilizing a pre-trained language model.

At 335C, document matching system 110 may determine whether the quantity of the one or more matching character strings meets or exceeds a threshold. At 340C, if the quantity of one or more matching character strings exceeds the threshold, document matching system 110 may generate an indication that the first document is associated with the second document. At 345C, if the quantity of one or more matching character strings does not exceed the threshold, document matching system 110 may generate an indication that the first document is not associated with the second document. This indication may be similar to 340A and 345A as discussed with reference to FIG. 3A.

While FIGS. 3A-3C describe applying NER algorithm to the first document, in some embodiments, the NER algorithm may also be applied to the second document to identify data fields and/or corresponding values. This may occur, for example, when the second document also has a sufficient and/or high quality to accurately apply the NER algorithm.

FIG. 4A depicts a flowchart illustrating a method 400A for identifying a matching data structure, according to some embodiments. Method 400A shall be described with reference to FIG. 1; however, method 400A is not limited to that example embodiment.

In an embodiment, document matching system 110 may utilize method 400A to determine whether a document matches a data structure. The foregoing description will describe an embodiment of the execution of method 400A with respect to document matching system 110. While method 400A is described with reference to document matching system 110, method 400A may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4A, as will be understood by a person of ordinary skill in the art.

In some embodiments, method 400A may be similar to method 300A but instead of comparing two documents, method 400A identifies a document as matching a data structure. For example, the data structure may correspond to an entity. Examples may include a particular delivery, job, shipment contract, individual, equipment, and/or other categorization. Method 400A may identify a match between a data structure and a document.

At 405A, document matching system 110 may classify a document into a document type using a first machine learning process. This may occur in a manner similar to 310A or 315A as described with reference to method 300A.

At 410A, document matching system 110 may identify a plurality of character strings corresponding to a plurality of respective data fields organized into a data structure stored on a database. The data structure may have already had defined data fields with a plurality of character strings. For example, an example data structure may correspond to a delivery. Data fields may include a pickup address, pickup date, pickup time, delivery address, expected delivery date, expected delivery time, actual delivery date, actual delivery time, recipient information, weight of load, driver name, and/or other data fields relevant to the data structure. The plurality of character strings may correspond to values for this field. A client system 120 may have defined these fields and/or values, which may be stored and/or managed by document matching system 110.

At 415A, document matching system 110 may generate a probability of match between the document and the data structure by applying the plurality of character strings from the data structure and text of the document to a second machine learning process. This may occur in a manner similar to 325A as described with reference to method 300A. Document matching system 110 may use data fields from the data structure to compare the plurality of characters strings.

At 420A, document matching system 110 may determine whether the probability of match exceeds a threshold. At 425A, document matching system 110 may determine whether the output meets or exceeds the threshold. At 430A, if the probability of match exceeds the threshold, document matching system 110 may generate an indication that the document is associated with the data structure. At 435A, if the probability of match does not exceed the threshold, document matching system 110 may generate an indication that the document is not associated with the data structure. The processes for 420A, 425A, 430A, and 435A may be similar to those described with reference to 330A, 335A, 340A, and 345A respectively.

As further described herein, when document matching system 110 determines that the document is associated with and/or matches the data structure, document matching system 110 may store an association between the two in document repository 116. For example, if the document is a driver's license and the data structure corresponds to a drive, document matching system 110 may associate the driver's license with the driver. In some embodiments, document matching system 110 may transmit the indication to client system 120 to identify the match.

FIG. 4B depicts a flowchart illustrating a method 400B for identifying a matching data structure using match thresholds corresponding to common data fields, according to some embodiments. Method 400B shall be described with reference to FIG. 1; however, method 400B is not limited to that example embodiment.

In an embodiment, document matching system 110 may utilize method 400B to determine whether a document matches a data structure. The foregoing description will describe an embodiment of the execution of method 400B with respect to document matching system 110. While method 400B is described with reference to document matching system 110, method 400B may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4B, as will be understood by a person of ordinary skill in the art.

In some embodiments, method 400B may be similar to method 300B but instead of comparing two documents, method 400B identifies a document as matching a data structure. For example, the data structure may correspond to an entity. Examples may include a particular delivery, job, shipment contract, individual, equipment, and/or other categorization. Method 400B may identify a match between a data structure and a document.

At 405B, document matching system 110 may classify a document into a document type using a first machine learning process. This may occur in a manner similar to 310A or 315A as described with reference to method 300A.

At 410B, document matching system 110 may identify a plurality of character strings corresponding to a plurality of respective data fields organized into a data structure stored on a database. This may occur in a manner similar to 410A as described with reference to method 400A.

At 415B, document matching system 110 may identify one or more matching character strings from the document by searching the document using the plurality of character strings extracted from the data structure. When identifying a matching character string, document matching system 110 may identify a character string from the document as a matching character string when the character string meets a match threshold corresponding to a data field common to the character string from the document and to a stored character string from the data structure. This may occur in a manner similar to 325B as described with reference to method 300B.

At 420B, document matching system 110 may generate a probability of match between the document and the data structure by applying the plurality of character strings from the data structure and the one or more matching character strings to a second machine learning process. This may occur in a manner similar to 325A or 415A as described with reference to methods 300A and 400A. A difference, however, may be that at 420B, the one or more matching characters strings are being applied rather than a portion or the full text from the document. Document matching system 110 may use data fields from the data structure to compare the plurality of characters strings.

At 425B, document matching system 110 may determine whether the probability of match exceeds a threshold. At 430B, document matching system 110 may determine whether the output meets or exceeds the threshold. At 435B, if the probability of match exceeds the threshold, document matching system 110 may generate an indication that the document is associated with the data structure. At 440B, if the probability of match does not exceed the threshold, document matching system 110 may generate an indication that the document is not associated with the data structure. The processes for 425B, 430B, 435B, and 440B may be similar to those described with reference to 330A, 335A, 340A, and 345A respectively.

FIG. 4C depicts a flowchart illustrating a method 400C for identifying a matching data structure using a quantity of matching character strings, according to some embodiments. Method 400C shall be described with reference to FIG. 1; however, method 400C is not limited to that example embodiment.

In an embodiment, document matching system 110 may utilize method 400C to determine whether a document matches a data structure. The foregoing description will describe an embodiment of the execution of method 400C with respect to document matching system 110. While method 400C is described with reference to document matching system 110, method 400C may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4C, as will be understood by a person of ordinary skill in the art.

In some embodiments, method 400C may be similar to method 300C but instead of comparing two documents, method 400C identifies a document as matching a data structure. For example, the data structure may correspond to an entity. Examples may include a particular delivery, job, shipment contract, individual, equipment, and/or other categorization. Method 400C may identify a match between a data structure and a document.

At 405C, document matching system 110 may classify a document into a document type using a first machine learning process. This may occur in a manner similar to 310A or 315A as described with reference to method 300A.

At 410C, document matching system 110 may identify a plurality of character strings corresponding to a plurality of respective data fields organized into a data structure stored on a database. This may occur in a manner similar to 410A as described with reference to method 400A.

At 415C, document matching system 110 may identify one or more matching character strings from the document by searching the document using the plurality of character strings extracted from the data structure. When identifying a matching character string, document matching system 110 may identify a character string from the document as a matching character string when the character string meets a match threshold corresponding to a data field common to the character string from the document and to a stored character string from the data structure. This may occur in a manner similar to 325B as described with reference to method 300B.

At 420C, document matching system 110 may determine whether a quantity of the one or more matching character strings exceeds a threshold. This may occur in a manner similar to 330C as described with reference to method 300C. A difference, however, may be that document matching system 110 may use data fields from the data structure to compare the plurality of characters strings.

At 425C, document matching system 110 may determine whether the quantity of the one or more matching character strings meets or exceeds a threshold. At 430C, if the quantity of one or more matching character strings exceeds the threshold, document matching system 110 may generate an indication that the document is associated with the data structure. At 435C, if the quantity of one or more matching character strings does not exceed the threshold, document matching system 110 may generate an indication that the document is not associated with the data structure. This may occur in a manner similar to

FIG. 5A depicts a flowchart illustrating a method 500A for generating a graphical user interface identifying a matching document, according to some embodiments. Method 500A shall be described with reference to FIG. 1; however, method 500A is not limited to that example embodiment.

In an embodiment, document matching system 110 may utilize method 500A to evaluate multiple documents and/or generate an indication of matching documents. The foregoing description will describe an embodiment of the execution of method 500A with respect to document matching system 110. While method 500A is described with reference to document matching system 110, method 500A may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5A, as will be understood by a person of ordinary skill in the art.

At 505A, document matching system 110 may receive a first document. For example, document matching system 110 may receive the first document from client system 120. In some embodiments, document matching system 110 may retrieve the first document from document repository 116.

At 510A, document matching system 110 may compare the first document to a plurality of documents and/or data structures using a machine learning algorithm to determine a respective probability of match for each document and/or data structure of the plurality of documents and data structures. To determine respective probabilities of match, document matching system 110 may use methods 300A, 300B, 400A, and/or 400B as previously described. These may be applied to individually compare the documents and data structures and to determine respective probabilities of match. For example, document matching system 110 may employ one or more machine learning algorithms as previously explained. In some embodiments, document matching system 110 may use methods 300C and/or 400C when determining a probability of match based on a quantity of matching character strings.

At 515A, document matching system 110 may identify a second document having a greatest probability of match. The second document may have the greatest probability of match relative to the other plurality of documents and/or data structures evaluated.

At 520A, document matching system 110 may generate a graphical user interface (GUI) displaying a first image corresponding to the first document and/or a second image corresponding to the second document. The GUI may include a color highlighting a portion of the first image and/or a portion of the second image corresponding to a data field identified by the machine learning model. Examples of such GUIs are depicted in FIGS. 2A and 2B along with their corresponding descriptions. Via the GUI, document matching system 110 may provide an indication to client system 120 of the second document which may correspond to the document predicted with the highest probability of matching the first document.

FIG. 5B depicts a flowchart illustrating a method 500B for generating a graphical user interface identifying a matching data structure, according to some embodiments. Method 500B shall be described with reference to FIG. 1; however, method 500B is not limited to that example embodiment.

In an embodiment, document matching system 110 may utilize method 500B to evaluate multiple data structures and/or generate an indication of matching data structures. The foregoing description will describe an embodiment of the execution of method 500B with respect to document matching system 110. While method 500B is described with reference to document matching system 110, method 500B may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5B, as will be understood by a person of ordinary skill in the art.

At 505B, document matching system 110 may receive a document. For example, document matching system 110 may receive the document from client system 120. In some embodiments, document matching system 110 may retrieve the document from document repository 116.

At 510B, document matching system 110 may compare the document to a plurality of documents and/or data structures using a machine learning algorithm to determine a respective probability of match for each document and/or data structure of the plurality of documents and data structures. To determine respective probabilities of match, document matching system 110 may use methods 300A, 300B, 400A, and/or 400B as previously described. These may be applied to individually compare the documents and data structures and to determine respective probabilities of match. For example, document matching system 110 may employ one or more machine learning algorithms as previously explained. In some embodiments, document matching system 110 may use methods 300C and/or 400C when determining a probability of match based on a quantity of matching character strings.

At 515B, document matching system 110 may identify a data structure having a greatest probability of match. The data structure may have the greatest probability of match relative to the other plurality of documents and/or data structures evaluated. As previously explained, this data structure may correspond to an entity which may have been defined by client system 120.

At 520B, document matching system 110 may generate a graphical user interface (GUI) displaying an image corresponding to the document and/or a GUI object corresponding to the data structure. The GUI may include a color highlighting a portion of the image and/or a portion of the GUI object corresponding to a data field identified by the machine learning model. Examples of such GUIs are depicted in FIGS. 2A and 2B along with their corresponding descriptions. The GUI object may be, for example, a collection of data fields and/or data values defined to represent the data structure. Via the GUI, document matching system 110 may provide an indication to client system 120 of the data structure which may correspond to the data structure predicted with the highest probability of matching the document.

FIG. 5C depicts a flowchart illustrating a method for generating a graphical user interface ranking one or more documents and/or data structures, according to some embodiments. Method 500C shall be described with reference to FIG. 1; however, method 500C is not limited to that example embodiment.

In an embodiment, document matching system 110 may utilize method 500C to evaluate multiple documents and/or data structures and generate an indication of potential matches. The foregoing description will describe an embodiment of the execution of method 500C with respect to document matching system 110. While method 500C is described with reference to document matching system 110, method 500C may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5C, as will be understood by a person of ordinary skill in the art.

At 505C, document matching system 110 may receive a document. For example, document matching system 110 may receive the document from client system 120. In some embodiments, document matching system 110 may retrieve the document from document repository 116.

At 510C, document matching system 110 may compare the document to a plurality of documents and/or data structures using a machine learning algorithm to determine a respective probability of match for each document and/or data structure of the plurality of documents and data structures. To determine respective probabilities of match, document matching system 110 may use methods 300A, 300B, 400A, and/or 400B as previously described. These may be applied to individually compare the documents and data structures and to determine respective probabilities of match. For example, document matching system 110 may employ one or more machine learning algorithms as previously explained. In some embodiments, document matching system 110 may use methods 300C and/or 400C when determining a probability of match based on a quantity of matching character strings.

At 515C, document matching system 110 may identify one or more documents and/or data structures having a respective probability of match that exceeds a threshold. The threshold may be predefined. For example, the threshold may correspond to a qualitative determination of relevance. This may apply to documents and/or data structures.

At 520C, document matching system 110 may generate a graphical user interface (GUI) displaying a ranking of the one or more documents and/or data structures based on respective probabilities of match. This ranking was previously described with reference to FIG. 2A. In some embodiments, the ranking may be used in conjunction with color highlighting as previously described. The GUI may also allow a user to select to view the one or more identified documents and/or data structures using client system 120.

FIG. 5D depicts a flowchart illustrating a method 500D for transmitting an identification of one or more matching documents and/or data structures via an API, according to some embodiments. Method 500D shall be described with reference to FIG. 1; however, method 500D is not limited to that example embodiment.

In an embodiment, document matching system 110 may utilize method 500D to evaluate multiple documents and/or data structures and generate an indication of potential matches. The foregoing description will describe an embodiment of the execution of method 500D with respect to document matching system 110. While method 500D is described with reference to document matching system 110, method 500D may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5D, as will be understood by a person of ordinary skill in the art.

At 505D, document matching system 110 may receive a document. For example, document matching system 110 may receive the document from client system 120. In some embodiments, document matching system 110 may retrieve the document from document repository 116.

At 510D, document matching system 110 may compare the document to a plurality of documents and/or data structures using a machine learning algorithm to determine a respective probability of match for each document and/or data structure of the plurality of documents and data structures. To determine respective probabilities of match, document matching system 110 may use methods 300A, 300B, 400A, and/or 400B as previously described. These may be applied to individually compare the documents and data structures and to determine respective probabilities of match. For example, document matching system 110 may employ one or more machine learning algorithms as previously explained. In some embodiments, document matching system 110 may use methods 300C and/or 400C when determining a probability of match based on a quantity of matching character strings.

At 515D, document matching system 110 may identify one or more documents and/or data structures having a respective probability of match that exceeds a threshold. The threshold may be predefined. For example, the threshold may correspond to a qualitative determination of relevance. This may apply to documents and/or data structures.

At 520D, document matching system 110 may transmit an identification of the one or more documents and/or data structures to a client system 120 via an API. This communication may or may not also include the communication of GUI data. Transmitting the identification without GUI data may inform client system 120 using less bandwidth. For example, this may be relevant in scenarios where GUIs are not needed for display. Client system 120 may use the identification to perform further processing. As previously described document matching system 110 and/or client system 120 may store the identification of the one or more matching documents and/or data structures. This identification may be linked with the document to associate the document with the one or more matching documents and/or data structures.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
classifying a first document as a first type using a first machine learning process;
classifying a second document as a second type using the first machine learning process, wherein the second document type differs from the first document type;
extracting a plurality of character strings corresponding to a plurality of respective data fields from the first document using a named-entity recognition algorithm;
generating a probability of match between the first document and the second document by applying the plurality of character strings extracted from the first document and text of the second document to a second machine learning process; and
based on the probability of match meeting a threshold, identifying a first portion of the first document and a second portion of the second document, wherein the first portion and the second portion correspond to a data field common to the first document and the second document.

2. The method of claim 1, wherein the text of the second document includes the full text of the second document.

3. The method of claim 1, wherein to determine the text of the second document, the method further comprises:
identifying one or more matching character strings from the second document by searching the second document using the plurality of character strings extracted from the first document, wherein a character string from the second document is identified as a matching character string when the character string meets a match threshold corresponding to a data field common to the character string from the second document and to an extracted character string from the first document.

4. The method of claim 3, wherein the match threshold corresponds to a quantity of matching characters between the character string from the second document and the extracted character string from the first document.

5. The method of claim 3, wherein the data field is a date and the match threshold corresponds to a proximity between a first date identified in the first document and a second date identified in the second document.

6. The method of claim 1, further comprising:
generating a graphical user interface (GUI) displaying an image of the second document, wherein the GUI includes a color highlighting a portion of the image corresponding to the second portion of the second document and wherein the color highlighting identifies the data field common to the first document and the second document.

7. The method of claim 6, further comprising:
extracting characters and bounding boxes from the second document via an optical character recognition process; and
applying the color highlighting to the portion of the image using the bounding boxes.

8. The method of claim 6, wherein the GUI displays a ranking of a plurality of documents including the second document based on a probability of match with the second document.

9. The method of claim 1, further comprising:
transmitting an identification of the first document to a client system via an API.

10. A system, comprising:
a memory; and
at least one processor coupled to the memory and configured to:
classify a first document as a first type using a first machine learning process;
classify a second document as a second type using the first machine learning process, wherein the second document type differs from the first document type;
extract a plurality of character strings corresponding to a plurality of respective data fields from the first document using a named-entity recognition algorithm;
generate a probability of match between the first document and the second document by applying the plurality of character strings extracted from the first document and text of the second document to a second machine learning process; and
based on the probability of match meeting a threshold, identify a first portion of the first document and a second portion of the second document, wherein the first portion and the second portion correspond to a data field common to the first document and the second document.

11. The system of claim 10, wherein the text of the second document includes the full text of the second document.

12. The system of claim 10, wherein to determine the text of the second document, the at least one processor is further configured to:
identify one or more matching character strings from the second document by searching the second document using the plurality of character strings extracted from the first document, wherein a character string from the second document is identified as a matching character string when the character string meets a match threshold corresponding to a data field common to the character string from the second document and to an extracted character string from the first document.

13. The system of claim 12, wherein the match threshold corresponds to a quantity of matching characters between the character string from the second document and the extracted character string from the first document.

14. The system of claim 12, wherein the data field is a date and the match threshold corresponds to a proximity between a first date identified in the first document and a second date identified in the second document.

15. The system of claim 10, wherein the at least one processor is further configured to:
generate a graphical user interface (GUI) displaying an image of the second document, wherein the GUI includes a color highlighting a portion of the image corresponding to the second portion of the second document and wherein the color highlighting identifies the data field common to the first document and the second document.

16. The system of claim 15, wherein the at least one processor is further configured to:
extract characters and bounding boxes from the second document via an optical character recognition process; and
apply the color highlighting to the portion of the image using the bounding boxes.

17. The system of claim 15, wherein the GUI displays a ranking of a plurality of documents including the second document based on a probability of match with the second document.

18. The system of claim 10, wherein the at least one processor is further configured to:
transmitting an identification of the first document to a client system via an API.

19. A non-transitory machine-readable storage medium that provides instructions that, if executed by a processor, are configurable to cause said processor to perform operations comprising:
classifying a first document as a first type using a first machine learning process;
classifying a second document as a second type using the first machine learning process, wherein the second document type differs from the first document type;
extracting a plurality of character strings corresponding to a plurality of respective data fields from the first document using a named-entity recognition algorithm;
generating a probability of match between the first document and the second document by applying the plurality of character strings extracted from the first document and text of the second document to a second machine learning process; and
based on the probability of match meeting a threshold, identifying a first portion of the first document and a second portion of the second document, wherein the first portion and the second portion correspond to a data field common to the first document and the second document.

20. The non-transitory machine-readable storage medium of claim 19, the operations further comprising:
generating a graphical user interface (GUI) displaying an image of the second document, wherein the GUI includes a color highlighting a portion of the image corresponding to the second portion of the second document and wherein the color highlighting identifies the data field common to the first document and the second document.
